(19) United States
(12) Patent Application Publication
(10) Pub. No.: US 2023/0050976 A1
(43) Pub. Date: Feb. 16, 2023

(54) FILE SYSTEM AWARE COMPUTATIONAL STORAGE BLOCK

(71) Applicant: Seagate Technology LLC, Fremont, CA (US)

(72) Inventor: Marc Tim JONES, Longmont, CO (US)

(21) Appl. No.: 17/401,076

(22) Filed: Aug. 12, 2021

(51) Int. Cl. G06F 16/18; G06F 16/13; G06F 13/16; G06F 13/42

(52) U.S. Cl. CPC G06F 16/1847; G06F 16/13; G06F 13/1668; G06F 13/4282; G06F 2213/0026

(57) ABSTRACT

The technology disclosed herein pertains to a system and method for providing the ability for a computational storage device (CSD) to understand data layout based upon automatic detection or host identification of the file system occupying a non-volatile memory express (NVMe) namespace, the method including receiving, at a CSD, a request to process a file using a computation program stored on the CSD, detecting a filesystem associated with the file within a namespace of CSD, mounting the filesystem on the CSD, interpreting a data structure associated with the file within the namespace, and reading the physical data blocks associated with the file into a computational storage memory (CSM) of the CSD.

### BACKGROUND

A computational storage device (CSD) is a storage device that provides persistent data storage and computational services. Computational storage is about coupling compute and storage to run applications locally on the data, reducing the processing required on the remote server, and reducing data movement. To do that, a processor on the drive is dedicated to processing the data directly on that drive, which allows the remote host processor to work on other tasks. Berkeley Packet Filter (BPF) is a technology used in certain CSD systems for processing data. It provides a raw interface to data link layers, permitting raw link-layer packets to be sent and received. eBPF (or Enhanced Berkeley Packet Filter) describes an computing instruction set (CIS) that has been selected for drive-based computational storage.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

The technology disclosed herein pertains to a system and method for providing the ability for a computational storage device (CSD) to understand data layout based upon automatic detection or host identification of the file system occupying a non-volatile memory express (NVMe) namespace, the method including receiving, at a CSD, a request to process a file using a computation program stored on the CSD, detecting a filesystem associated with the file within a namespace of CSD, mounting the filesystem on the CSD, interpreting a data structure associated with the file within the namespace, and reading the physical data blocks associated with the file into a computational storage memory (CSM) of the CSD.

These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates a schematic diagram of an example filesystem-aware computational storage device (CSD) .

FIG. 2 illustrates example operations of the filesystem-aware CSD system disclosed herein.

FIG. 3 illustrates alternative example operations of the filesystem-aware CSD system disclosed herein.

FIG. 4 illustrates an example processing system that may be useful in implementing the described technology.

### DETAILED DESCRIPTION

A computational storage device (CSD) is a storage device that provides persistent data storage and computational services. Computational storage is about coupling compute and storage to run applications locally on the data, reducing the processing required on the remote server, and reducing data movement. To do that, a processor on the drive is dedicated to processing the data directly on that drive, which allows the remote host processor to work on other tasks.

Local processing of data on a drive requires that the host manages the processing for block-based CSDs. This is due to the host being the only entity that understands the structure of the data on a disk (for example, how “/data/blob001.txt” maps to a random collection of blocks on a disk). In a non-CSD system, the host manages the disk structure through a filesystem which treats the disk as a bag of blocks. This requires that the host is involved in all operations of computational storage. Implementations disclosed herein allow a drive to understand the disk structure for remotely controlled or local autonomous operations.

Specifically, one or more implementations disclosed herein provides the ability for a CSD to understand the data layout on its local memory based upon automatic detection or host identification of the file system occupying the memory namespace. In one or more implementations where the local memory is non-volatile memory (NVM), a processor of the CSD may be able to detect the data layout of the NVMe namespace using the technology disclosed herein. Once the filesystem is identified (such as Ext4, ZFS, etc.) the CSD can use this information to interpret the metadata contained in the namespace. This allows the CSD to map higher level file objects to ranges of blocks within the CSD memory using extents, or other metadata structures given the specific filesystem.

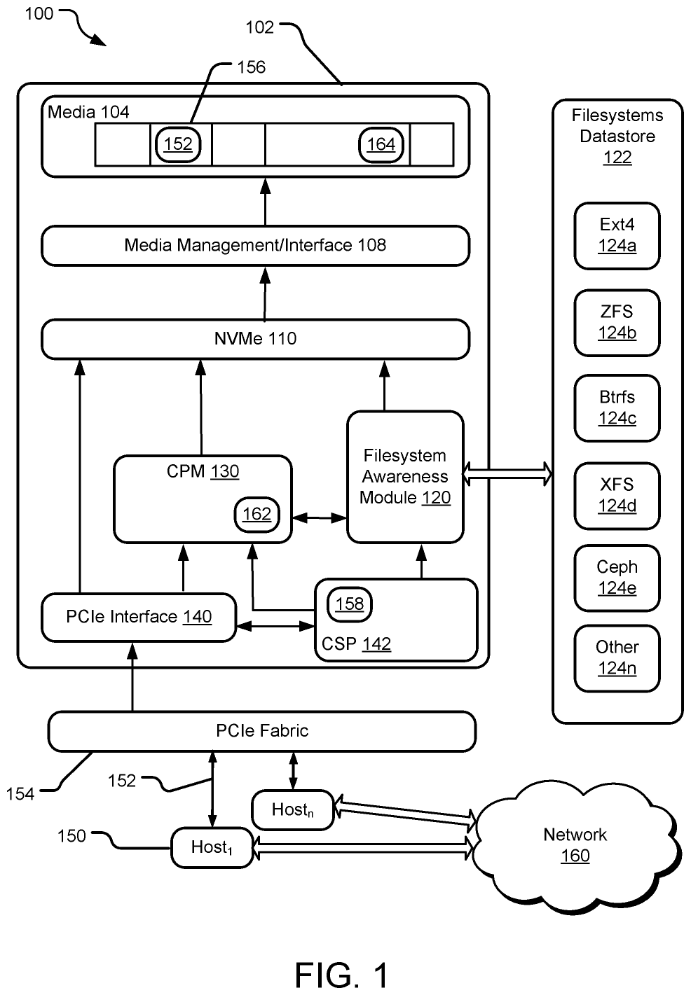

FIG. 1 illustrates a schematic diagram of a computational storage device (CSD) system 100 including a filesystem-aware CSD. The CSD system 100 may include a CSD 102 that is configured to communicate with one or more hosts 150 using a peripheral component interface express (PCIe) fabric 154. Specifically, the CSD 102 may include a PCIe interface 140 that allows various components of the CSD 102 to communicate using the PCIe fabric 154. In one implementation, the CSD 102 includes media 104 that may be used for storing data. The media 104 may be embodied by various types of processor-readable storage media, such as hard disc media, a storage array containing multiple storage devices, optical media, solid-state drive technology, ROM, RAM, and other technology. In some implementations the memory 104 may be non-volatile memory (NVM) that may include one or more of flash memory, ferroelectric random-access memory (FeRAM), magnetic random-access memory (MRAM), phase-change memory (PCM), Resistive random-access memory (RRAM), etc.

The PCIe interface 140 may communicate with the media 104 using a NVM express (NVMe) 110 and a media management interface 108. In one implementation, the CSD 102 may also include a computing program manager (CPM) 130 that processes one or more computation programs that are stored at the CSD 102 level.

The CSD 102 may also include a computational storage processor (CSP) 142 working with the CPM 130 to provide processing of data at the media 104. The CSP 142 may include one or more computational instruction slots (CISs) where instruction sets or programs can be loaded to work on data stored in the media 104. For example, the CSP 142 may store one or more computation programs that processes data on the media 104. The computation programs, which may also be referred to as a filter program, may be any program that processes data, such as a query program, an encryption program, a decryption program, a machine learning algorithm, etc.

The CSD 102 may receive a request from one or more of the hosts 150 for or processing a file using the computation program. In one implementation, the host 150 may identify the name of the file and the namespace within the memory 104 where the file resides. For example, the host 150 may identify a file 152 that resides at a namespace 156 to be processed by a computation program 158 stored in the CSP 142. An example of the file 152 may be ‘/data/b1ob001.txt.’ In response to receiving the request, the CSD 102 may identify the filesystem associated with the namespace 156. In one implementation, the CSD 103 may also identify the metadata associated with the filesystem, wherein the metadata describes the format and structure of the data contained within the filesystem.

Specifically, the CSD 102 may include a filesystem awareness module (FAM) 120 that is configured to analyze the metadata associated with various namespaces within the memory 102 and identify the related filesystems thereof. The FAM 120 may be communicatively connected with a filesystems datastore 122 that stores a plurality of filesystems 124. The example filesystems 124 may include Ext4 124a, ZFS 124b, Btrfs 124c, XFS 124d, Ceph 124e, or other filesystems 124n. Each of the filesystems 124 may provide data structure identifying how data is stored and retrieved from a particular namespace, such as the namespace 152. Specifically, the filesystems 124 provide data structure for storing, organizing, and retrieving data from the namespaces in the memory 104. Each of the filesystems 124 may also specify one or more related driver routines that are required to access the file within the namespace.

Once identified, the FAM 120 instructs the CPM 130 to mount the identified filesystem 124 and its related drivers onto a RAM or cache 162 within the CPM 130. For example, if the CPM 130 determines that the filesystem associated with the namespace 156 is ZFS 124b, the CPM 130 may copy and load ZFS 124b and related drivers to the cache 162. Once the filesystem 124 is successfully mounted on the cache 162, the file 152 is identified within the filesystem structure and physical blocks on the media 104 associated with the file 152 are identified. Subsequently, the data from the physical blocks associated with the file 152 are read into the CPM 130 for the CSP 142 to execute the computation program 158 on the copied data from the physical block. The results of the execution of the computation program are stored on the cache 162. Subsequently, the host 150 is able to access the results of the execution of the computation program using the PCIe interface 140.

In one implementation, the filesystem 124 may restrict operations by the CPM 130 and the CSP 142 on the file 152 to read only. In other words, the CPM 130 may read the data from the physical blocks associated with the file 152 and process them in the cache 162 using the computation program 158. However, the CPM 130 is not allowed to write the processed data back on the physical blocks associated with the file 152. This avoids any contention with the host 150 managing the filesystem associated with the file 152. In one implementation, the operation of mounting the filesystem 124 to the cache 162 results in only read operations to the media 104 and therefore, the drivers of the filesystems 124 are minimal as they don't require host write operations.

In alternative implementations, where the CSD 102 is not able to autodetect the filesystem 124 associated with the file 152, the host 150 may provide the file system information to the CSD 102. For example, the host 150 may notify the CSD 102 that a filesystem associated with a file 164 is XFS 124d. In such an implementation, the host 150 syncs with the CSD 102 to ensure the filesystem buffers and the related metadata are flushed to the CSD 102 before performing any operation to ensure that the CSD 102 sees the complete version of the filesystem for the file 164. In such implementation, the FAM 120 unmounts the filesystem either after the computation operation 158 is complete or maintains its state until the host 150 specifies the FAM 120 to unmount the filesystem.

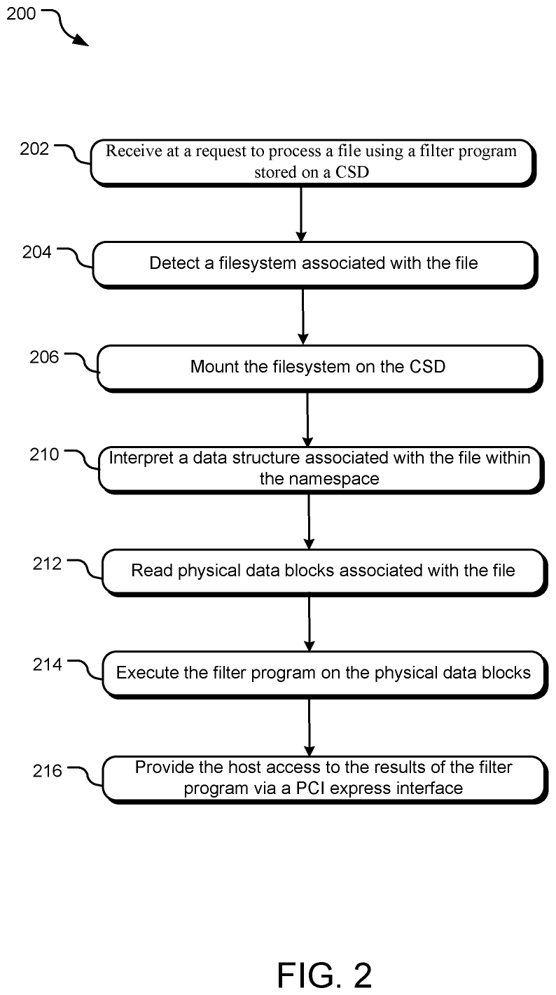

FIG. 2 illustrates example operations 200 of the filesystem-aware CSD system disclosed herein. At operation 202 a CSD receives a request to process a file using a computation program. For example, the computation program may be stored on a computational storage processor of the CSD. At operation 204, the CSD detents a filesystem associated with the file within a given namespace of the CSD. For example, operation 204 may detect the filesystem based on metadata associated with a namespace of the file. An operation 206 mounts the detected filesystem to the CSD. Subsequently, an operation 210 interprets a data structure associated with the file within the namespace and an operation 212 reads physical data blocks associated with the file into a computational storage memory (CSM) of the CSD. An operation 214 executes the computation program on the physical data blocks in the CSM and an operation 216 provides the host access to the results of the filter program via a PCI express interface.

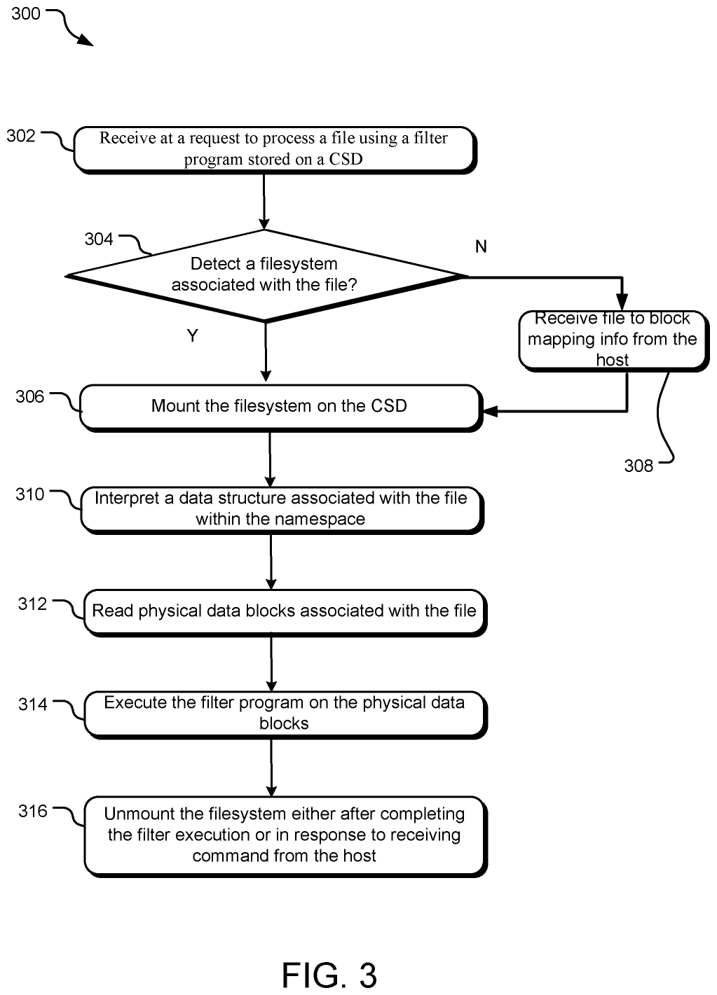

FIG. 3 illustrates alternative example operations 300 of the filesystem-aware CSD system disclosed herein. At operation 302 a CSD receives a request to process a file using a computation program. For example, the computation program may be stored on a computational storage processor of the CSD. An operation 304 determines if it is able to detect a filesystem associated with the file. If so, an operation 306 mounts the filesystem to the CSD. If not, an operation 308 receives file to block mapping information from the host.

Subsequently, an operation 310 interprets a data structure associated with the file within the namespace and an operation 312 reads physical data blocks associated with the file into a computational storage memory (CSM) of the CSD. An operation 314 executes the computation program on the physical data blocks in the CSM and an operation 316 unmounts the filesystem either after completing the filter execution or in response to receiving command from the host.

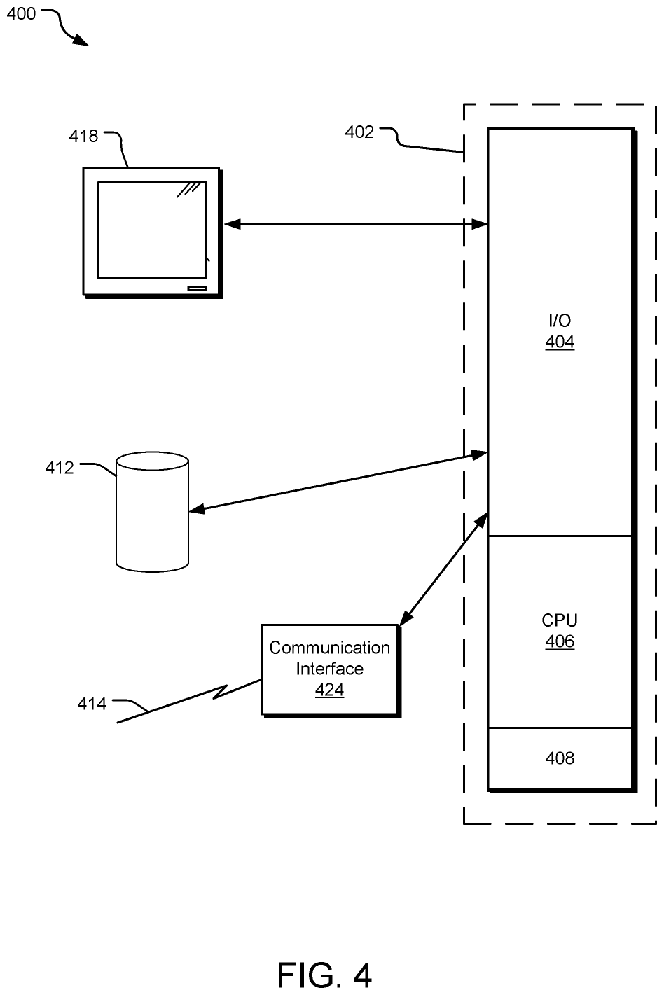

FIG. 4 illustrates an example processing system 400 that may be useful in implementing the described technology. The processing system 400 is capable of executing a computer program product embodied in a tangible computer-readable storage medium to execute a computer process. Data and program files may be input to the processing system 400, which reads the files and executes the programs therein using one or more processors (CPUs or GPUs). Some of the elements of a processing system 400 are shown in FIG. 4 wherein a processor 402 is shown having an input/output (I/O) section 404, a Central Processing Unit (CPU) 406, and a memory section 408. There may be one or more processors 402, such that the processor 402 of the processing system 400 comprises a single central-processing unit 406, or a plurality of processing units. The processors may be single core or multi-core processors. The processing system 400 may be a conventional computer, a distributed computer, or any other type of computer. The described technology is optionally implemented in software loaded in memory 408, a storage unit 412, and/or communicated via a wired or wireless network link 414 on a carrier signal (e.g., Ethernet, 3G wireless, 8G wireless, LTE (Long Term Evolution)) thereby transforming the processing system 400 in FIG. 4 to a special purpose machine for implementing the described operations. The processing system 400 may be an application specific processing system configured for supporting a distributed ledger. In other words, the processing system 400 may be a ledger node.

The I/O section 404 may be connected to one or more user-interface devices (e.g., a keyboard, a touch-screen display unit 418, etc.) or a storage unit 412. Computer program products containing mechanisms to effectuate the systems and methods in accordance with the described technology may reside in the memory section 408 or on the storage unit 412 of such a system 400.

A communication interface 424 is capable of connecting the processing system 400 to an enterprise network via the network link 414, through which the computer system can receive instructions and data embodied in a carrier wave. When used in a local area networking (LAN) environment, the processing system 400 is connected (by wired connection or wirelessly) to a local network through the communication interface 424, which is one type of communications device. When used in a wide-area-networking (WAN) environment, the processing system 400 typically includes a modem, a network adapter, or any other type of communications device for establishing communications over the wide area network. In a networked environment, program modules depicted relative to the processing system 400 or portions thereof, may be stored in a remote memory storage device. It is appreciated that the network connections shown are examples of communications devices for and other means of establishing a communications link between the computers may be used.

In an example implementation, a user interface software module, a communication interface, an input/output interface module, a ledger node, and other modules may be embodied by instructions stored in memory 408 and/or the storage unit 412 and executed by the processor 402. Further, local computing systems, remote data sources and/or services, and other associated logic represent firmware, hardware, and/or software, which may be configured to assist in supporting a distributed ledger. A ledger node system may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 408 and/or the storage unit 412 and executed by the processor 402.

The processing system 400 may be implemented in a device, such as a user device, storage device, IoT device, a desktop, laptop, computing device. The processing system 400 may be a ledger node that executes in a user device or external to a user device.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A method, comprising:
receiving, at a computational storage device (CSD), a request to process a file using a computation program stored on the CSD;
detecting a filesystem associated with the file within a namespace of CSD;
mounting the filesystem on the CSD;
interpreting a data structure associated with the file within the namespace; and
reading physical data blocks associated with the file into a computational storage memory (CSM) of the CSD.

2. The method of claim 1, further comprising executing the computation program on the physical data blocks in the CSM.

3. The method of claim 2, further comprising providing access to the result of the computation program execution to a host.

4. The method of claim 3, wherein providing access to the result of the computation program execution to a host further comprising providing access to the result of the computation program execution to a host via a PCI express interface.

5. The method of claim 1, wherein a filesystem aware module of the CSD receives identification of the filesystem associated with the file from the host.

6. The method of claim 5, further comprising syncing with the host before mounting the filesystem on the CSD.

7. The method of claim 6, further comprising keeping the file system mounted until receiving an unmount instruction from the host.

8. The method of claim 1, wherein the mounted filesystem restricts the computation program operations to read only.

9. One or more tangible computer-readable storage media encoding computer-executable instructions for executing on a computer system a computer process, the computer process comprising:
receiving, at a computational storage device (CSD), a request to process a file using a computation program stored on the CSD;
detecting a filesystem associated with the file within a namespace of CSD;
mounting the filesystem on the CSD;
interpreting a data structure associated with the file within the namespace; and
reading physical data blocks associated with the file into a computational storage memory (CSM) of the CSD.

10. The one or more tangible computer-readable storage media of claim 9, wherein the computer process further comprising executing a computation program on the physical data blocks in the CSM.

11. The one or more tangible computer-readable storage media of claim 10, wherein the computer process further comprising providing access to the result of the computation program execution to a host.

12. The one or more tangible computer-readable storage media of claim 11, wherein providing access to the result of the computation program execution to a host further comprising providing access to the result of the computation program execution to a host via a PCI express interface.

13. The one or more tangible computer-readable storage media of claim 9, wherein a filesystem aware module of the CSD receives identification of the filesystem associated with the file from the host.

14. The one or more tangible computer-readable storage media of claim 13, wherein the computer process further comprising syncing with the host before mounting the filesystem on the CSD.

15. The one or more tangible computer-readable storage media of claim 14, wherein the computer process further comprising keeping the file system mounted until receiving an unmount instruction from the host.

16. The one or more tangible computer-readable storage media of claim 9, wherein the mounted filesystem restricts the computation program operations to read only.

17. A system, comprising:
a PCIe interface configured to communicate with computational storage memory (CSM) of a computational storage device (C SD) using an NVMe interface;
a computational storage processor (CSP) configured to communicate with one or more hosts using the PCIe interface;
a filesystem awareness module configured on a computational program memory (CPM) to access one or more of a plurality of filesystems;
wherein the CSP is configured to:
receive a request to process a file using a computation program stored on the CSD;
detect one of the plurality of filesystems as a filesystem associated with the file within a namespace of CSD; and
mount the filesystem on the CSD using the filesystem awareness module.

18. The system of claim 17, wherein the CSP is further configured to:
interpret a data structure associated with the file within the namespace; and
read physical data blocks associated with the file into a computational storage memory (CSM) of the CSD.

19. The system of claim 17, wherein the CSP is further configured to provide access to the result of the computation program execution to the host.

20. The system of claim 17, wherein the mounted filesystem restricts the computation program operations to read only.
